(19) United States
(12) Patent Application Publication
(10) Pub. No.: US 2015/0351379 A1
(43) Pub. Date: Dec. 10, 2015

(54) RODENT REPELLENT FOR VEHICLE ENGINE

(71) Applicant: Earl Raymond Lyons, Udall, MO (US)

(72) Inventor: Earl Raymond Lyons, Udall, MO (US)

(21) Appl. No.: 14/298,509

(22) Filed: Jun. 6, 2014

(51) Int. Cl. A01M 29/12

(52) U.S. Cl. CPC A01M 29/12

(57) ABSTRACT

A rodent repellent for a vehicle is provided. The rodent repellent may include a medium and a cat urine scent. The medium may secure and deliver the cat urine scent. The medium may be an absorbent pad with an adhesive layer. Once the cat urine scent is absorbed by the absorbent pad, the absorbent pad may be attached to an engine of a car to deter rodents from entering and destroying the engine.

### BACKGROUND OF THE INVENTION

The present invention relates to a rodent repellent and, more particularly, to a rodent repellent for engines.

Currently, rodents enter engine compartments and destroy wiring components. The rodents may make the vehicle inoperable, requiring the vehicle to be fixed.

As can be seen, there is a need for methods and devices for repelling rodents from entering and destroying an engine compartment.

### SUMMARY OF THE INVENTION

In one aspect of the present invention, a rodent repellent comprises: a medium; and at least one of a synthetic cat urine scent and cat urine within the medium.

In another aspect of the present invention, a method of deterring rodents from entering an engine compartment comprises: providing at least one of a synthetic cat urine scent and cat urine; providing a medium for holding the at least one of the synthetic cat urine scent and the cat urine; combining the at least one of the synthetic cat urine scent and the cat urine with the medium; and placing the medium under a hood of a car.

These and other features, aspects and advantages of the present invention will become better understood with reference to the following drawings, description and claims.

### BRIEF DESCRIPTION OF THE DRAWINGS

FIG. 1 is a side elevation view of the present invention in use;

FIG. 2 is a detail side elevation view of the engine of the vehicle; and

FIG. 3 is a flow chart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a rodent repellent for a vehicle. The rodent repellent may include a medium and a cat urine scent. The medium may secure and deliver the cat urine scent. The medium may be an absorbent pad with an adhesive layer. Once the cat urine scent is absorbed by the absorbent pad, the absorbent pad may be attached to an engine of a car to deter rodents from entering and destroying the engine.

The present invention includes a scent of male cat urine saturated on a medium to distribute the scent inside the hood of a vehicle to prevent rodent damage to internal wiring. Cat urine scent deters the rodents from entering vehicle and destroying the engine.

Referring to FIG. 1 through 3, the present invention may include a rodent repellent 10. The rodent repellent 10 may include a medium. The rodent repellent 10 may further include cat urine scent which may include at least one of a synthetic cat urine scent and cat urine. The synthetic cat urine scent may contain ammonium. The cat urine sent may be within the medium and the medium may be placed underneath the hood of a vehicle 11.

The medium of the present invention may include any medium that may contain the cat urine scent. In certain embodiments, the medium may be an absorbent pad 12. The absorbent pad 12 may absorb and contain the cat urine scent. Further, the absorbent pad 12 may release the scent at a slower rate, so that the rodent repellent 10 remains effective for a long period of time.

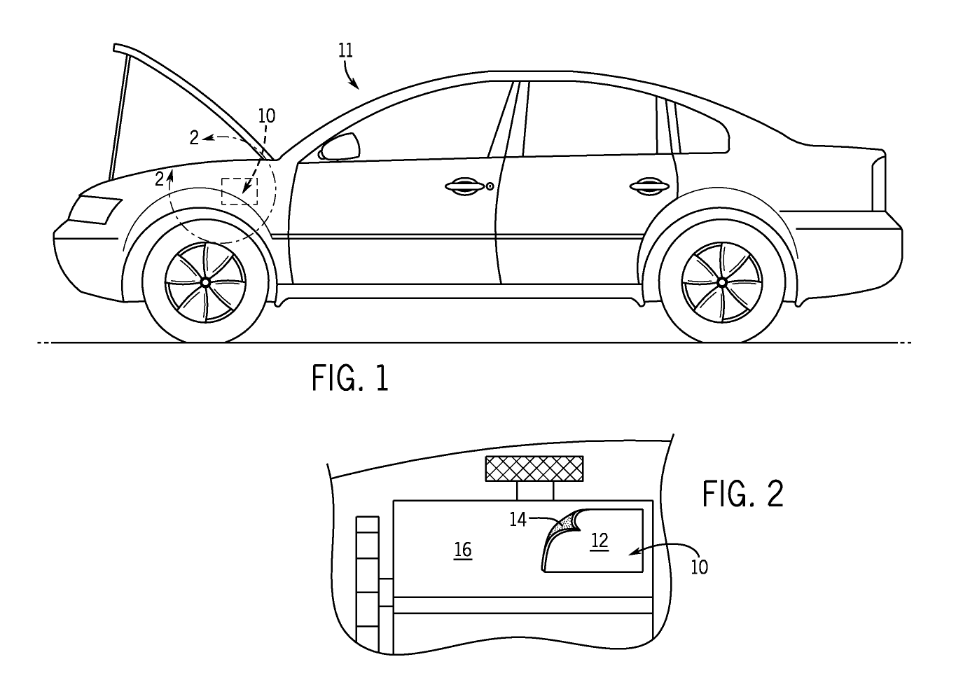

In certain embodiments, the absorbent pad 12 may further include an adhesive layer 14. Therefore, the absorbent pad 12 may be adhered to an object within the hood of the vehicle 11. As illustrated in FIG. 2, the absorbent pad 12 may be adhered directly to the engine 16 of the vehicle 11 by the adhesive layer 14. Therefore, the adhesive pad 12 may deliver the cat urine scent directly to the intended protected component of the vehicle 11.

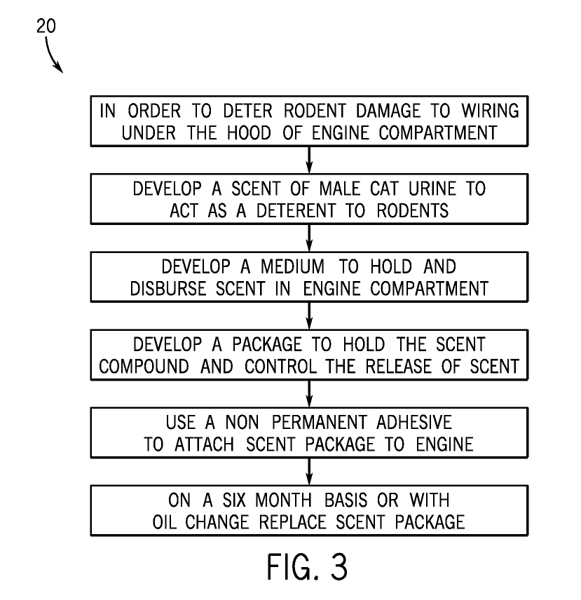

As illustrated in the flow chart of FIG. 3, the present invention may include a flowchart 20 including a method of deterring rodents from entering an engine compartment. The method may include the following. The cat urine scent, including at least one of a synthetic cat urine scent and cat urine, may be provided. A medium for holding the cat urine scent is provided. The medium and the cat urine scent are combined so that the medium contains that cat urine scent. The medium is then placed under the hood of a vehicle. When the medium is an absorbent pad with an adhesive layer, the absorbent pad is adhered within the hood of vehicle, such as to the engine. The medium may be replaced on a periodical basis. For example the medium may be replaced every six months, or with every oil change.

It should be understood, of course, that the foregoing relates to exemplary embodiments of the invention and that modifications may be made without departing from the spirit and scope of the invention as set forth in the following claims.

What is claimed is:

1. A rodent repellent comprising:
a medium; and
at least one of a synthetic cat urine scent and cat urine within the medium.

2. The rodent repellent of claim 1, wherein the medium comprises an absorbent pad.

3. The rodent repellent of claim 2, further comprising an adhesive layer attached to the absorbent pad.

4. The rodent repellent of claim 1, wherein the synthetic cat urine comprises ammonium.

5. A method of deterring rodents from entering an engine compartment comprising:
providing at least one of a synthetic cat urine scent and cat urine;
providing a medium for holding the at least one of the synthetic cat urine scent and the cat urine;
combining the at least one of the synthetic cat urine scent and the cat urine with the medium; and
placing the medium under a hood of a car.

6. The method of claim 5, wherein the synthetic cat urine scent comprises ammonium

7. The method of claim 5, wherein the medium comprises an absorbent pad.

8. The method of claim 7, wherein the absorbent pad further comprises an adhesive layer.

9. The method of claim 8, further comprising the step of adhering the adhesive within the hood of a vehicle.

10. The method of claim 9, further comprising the step of adhering the adhesive layer to an engine.

11. The method of claim 5, further comprising the step of replacing the absorbent pad on a periodical basis.

12. The method of claim 10, wherein the periodical basis is every six months.
